(19) United States
(12) Patent Application Publication
(10) Pub. No.: US 2026/0310683 A1
(43) Pub. Date: Oct. 8, 2026

(54) Ordering of Displayed Data Objects based on Similarity with Already-Linked Data Objects

(71) Applicant: PayPal, Inc., San Jose, CA (US)

(72) Inventor: Chithrashree Vijayaraj, Hosur (IN)

(21) Appl. No.: 19/170,953

(22) Filed: Apr. 4, 2025

(51) Int. Cl. G06F 16/26; G06F 3/04842; G06F 9/451

(52) U.S. Cl. CPC G06F 16/26; G06F 3/04842; G06F 9/451

(57) ABSTRACT

A data structure includes a first field and a second field to link a data object of a first type and a data object of a second type to an account. A computing system selects a data object of the second type to update the second field by accessing the first field and, based on the access, accesses a second data store to retrieve a data object of a third type. A third data store is accessed to determine a set of data objects of the second type. The system standardizes the set of data objects of the second type and the set of data objects of the third type to compare the data objects. Based on the comparison, the system orders the set of data objects and causes display of the ordered set. The user interface displays a subset of the set of data objects according to the ordering.

### BACKGROUND

### Technical Field

This disclosure relates generally to data store management, and, more specifically, to ordering data objects on a user interface based on existing data links.

### Description of the Related Art

Computing systems utilize various data stores to store data objects according to various organizations (e.g., using relational databases, key/value stores, etc.). Stored data objects may be linked or related in various ways. When a user initiates a query that returns a certain type of data object, it may be challenging to order voluminous query results in a manner that emphasizes relevant results.

### BRIEF DESCRIPTION OF THE DRAWINGS

FIG. 1 is a block diagram illustrating an example of a data processing system with multiple data stores and links between data objects, according to some embodiments.

FIG. 2 is a diagram illustrating example operations to emphasize data objects for linking, according to some embodiments.

FIGS. 3A and 3B are diagrams illustrating example graphical user interfaces with different interface techniques, according to some embodiments.

FIG. 4 is a flow diagram illustrating an example of a method for ordering data objects, according to some embodiments.

FIG. 5 is a block diagram illustrating an example computing system, according to some embodiments.

### DETAILED DESCRIPTION

As discussed above, it may be challenging to emphasize relevant data objects on interfaces utilized by users of a computer system. Disclosed techniques emphasize relevant data objects based on analysis of existing links between data objects.

As one example, consider a user interface that allows users to add security layers to their account such as multi-factor authentication methods that utilize cryptographic techniques and an additional factor (e.g., in addition to a username and password) to authenticate users. Users may become frustrated and fail to add two-factor authentication if the procedure is cumbersome, which may introduce additional attack vectors to a secure computer system.

Therefore, in some embodiments the computer system generates an ordered list of two-factor authentication methods in which more relevant methods are emphasized (e.g., listed earlier in order, displayed using a different size or font, etc.). As one example, the computer system may determine whether a user account is linked to other accounts that may already have two-factor authentication setup (e.g., a gaming account may be linked to a streaming account, email account, etc.). The computer system may compare any existing authentication methods for those accounts with available authentication methods to be added. Based on the comparison, the computer system may order the available authentication methods to emphasize matches (e.g., if the user has previously used biometric authentication, it may be emphasized relative to other techniques such as SMS, authenticator applications, physical cryptographic devices, etc.). In this manner, a user advantageously may not have to parse through a potentially voluminous list of two-factor authentication methods, thereby increasing the likelihood that the user will select a two-factor authentication method for the account.

To generate the ordering of the authentication methods, the computer system may sort the authentication methods into a first subset that includes an authentication method that has a threshold similarity match with a prior authentication method and into a second subset that does not have the threshold similarity value match. Additionally, in some embodiments, the computer system may access metadata associated with the other account to determine other inputs to the ordering. As one example, metadata may indicate recency of use for one or more authentication methods, which may be used to emphasize more-recently-used methods.

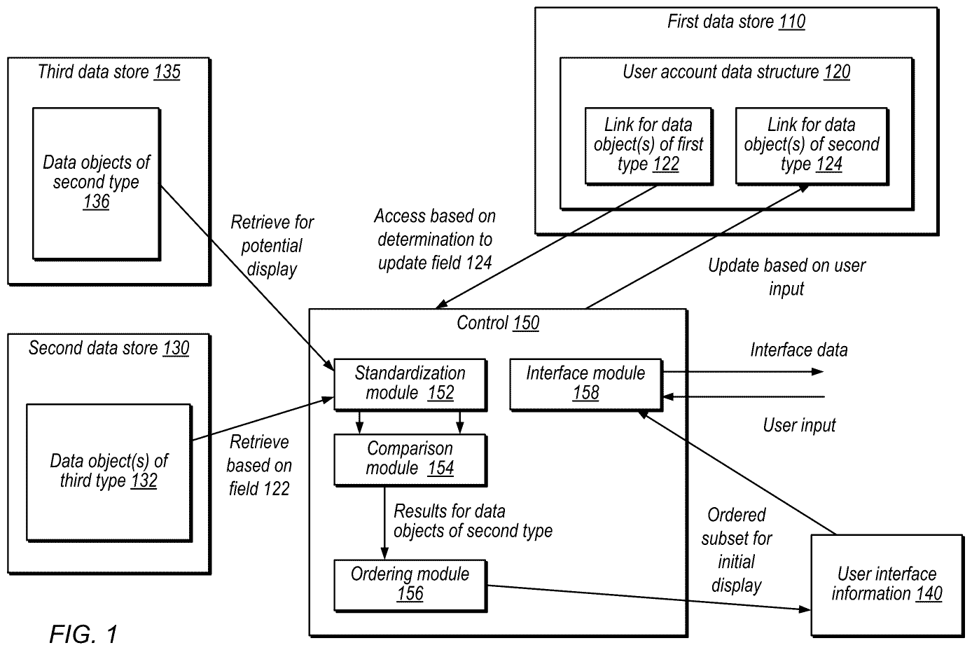

FIG. 1 is a block diagram illustrating an example of a data processing system with multiple data stores and links between data objects, according to some embodiments. In the illustrated example, FIG. 1 includes first data store 110, second data store 130, third data store 135, and control 150 (a software module also referred to as “control module 150”). Control module 150 is operable to use an already-linked data object in first data store 110 to determine which retrieved data objects from third data store 135 to emphasize (e.g., based on accessing data in second data store 130).

First data store 110, in some embodiments, is configured to store user account data structure 120. User account data structure 120 includes a first field usable to store link for data object(s) of a first type 122 and a second field usable to store link for data object(s) of a second type 124. Links 122 and 124 indicate locations in a data store at which a linked data object (potentially of a different type) may be stored. For example, links 122 and 124 may include pointers, indexes, identifiers or the like to encode the location of another data object.

Various disclosed data stores (e.g., 110, 130, and 135) may be implemented in one or more memories using various structures, e.g., relational databases, key/value stores, custom tables, etc. Non-limiting examples of data objects include, without limitation: a JavaScript Object Notation (JSON) data object, a C structure, a single value of a given data type, an array, a hash table, a tree, a linked list, a graph, etc. A given data object may encode one or more fields, some of which may be usable to link to other data objects.

For example, link 122 in account data structure 120 is usable to link a data object of a first type to a data object of a third type. A user may add a link for a data object of a second type using field 124. As discussed in detail below, the system may emphasize options for linking in field 124 based on one or more existing links 122.

Second data store 130, in some embodiments, is configured to store data object(s) of a third type 132. One of more of these stored objects may be linked to objects of the first type. In some embodiments, the first and second data stores 110 and 130 are separate and distinct (e.g., they may be maintained by separate computing systems) while in other embodiments second data store 130 may be implemented as a part of first data store 110, for example, and therefore may be maintained by the same computing system. Data stores maintained by different computing systems may be accessed via one or more networks, e.g., using appropriate application programming interface (API) calls, communication protocols, etc.

Third data store 135, in some embodiments, is configured to store data object(s) of a second type 136, e.g., which may be eligible for linking in field 124.

Control module 150 is configured to perform various operations relating to populating a link 124, as discussed in detail below. In the illustrated example, control module 150 includes standardization module 152, comparison module 154, ordering module 156, and interface module 158.

Standardization module 152 is operable to perform one or more standardization operations. For example, standardization module 152 may standardize formatting, encoding, or both of data objects of various types such as 132 and 136. For example, a standardization operation may include lowercasing text corresponding to a data object, removing spaces between characters of a data object, or both. Standardization may facilitate comparison of objects from different sources.

Comparison module 154 is operable to perform one or more comparison operations between data objects. A comparison operation may operate on one or multiple fields of two data objects being compared. The result of the comparison may be binary (e.g., the comparison met or did not meet a comparison threshold) or may be encoded at other granularities, e.g., a percentage match, a match score, a match probability, etc. For example, comparison module 154 may perform a contain-match operation or a cosine similarity operation. The comparison may be of a single data object field or multiple fields, potentially including metadata fields.

Ordering module 156 is operable to generate user interface information 140. Information 140 may be usable to generate a user interface on a display device, for example. User interface information 140 indicates an order of data objects for their display, e.g., based on their similarity as indicated by the output of comparison module 154. In particular, ordering module 156 may prioritize data objects of the second type from data store 135 for emphasis on a displayed user interface.

In some embodiments, ordering module 156 orders data objects 136 based on additional inputs (in addition to the output of comparison module 154). For example, ordering module 156 may receive metadata associated with data objects 132, such as recency of use, total number of uses, etc. This metadata may be indicative of user preference for already-linked data objects 132. Ordering module 156 may therefore order data objects 136 based on this metadata in addition to the comparison results. Ordering module 156 may also receive metadata associated with data objects 136 and may increase or decrease emphasis of a given data object 136 based on characteristics associated with its metadata (e.g., whether it is associated with open source or open protocol characteristics).

Interface module 158 is operable to generate interface data based on user interface information 140 and to receive user input (e.g., from a user of a computer system). For example, interface module 158 may output data to a display device such as a screen and receive input via a touchscreen, mouse and keyboard, gesture capture device, etc. The user input may select from among displayed data objects, for example.

In some embodiments, control module 150 uses different interface protocols, e.g., different application programming interfaces for two or more of: accesses to first data store 110, accesses to second data store 130, accesses to third data store 135, and communications by interface module 158. Some of these interfaces may be network interfaces (e.g., via the web) while others may be internal interfaces of a computing system (e.g., app-based APIs, etc.)

During operation, in some embodiments, control module 150 accesses second data store 130 and third data store 135 based on a determination to update the second field usable to store link for data object(s) of a second type 124. Based on the link for data object(s) of a first type 122, control module 150 is operable to retrieve, from second data store 130, data object(s) of a third type 132 that correspond to data object(s) of a first type. Additionally, control module 150 is operable to retrieve linked data objects of a second type from third data store 135. In some embodiments, the quantity of retrieved data object(s) of a second type 136 may be too numerous to practically display on a single screen of a user interface; therefore, the linked data objects from data store 130 may be used to determine which data objects from data store 135 to emphasize. Standardization module 152 standardizes the retrieved results for comparison (which may improve comparison accuracy, speed, or both). Comparison module 154 outputs comparison results and ordering module 156 emphasizes strong matches for display on the user interface (e.g., where emphasis may include display in a conspicuous region of the user interface, display in bold, display using a larger size, etc.).

The computer system may advantageously enhance presentation of data object(s) of a second type 136 on the user interface by emphasizing matching data objects, which a user may be more likely to want to select for linking in field 124. By emphasizing, on a user interface, data object(s) of second type 136 that match, e.g., within the threshold similarity value, data object(s) of third type 132, a user is more likely to select a data object(s) of a second type 136. When the data object(s) of a second type 136 correspond to a dual-factor authentication protocol for the user account corresponding to user account data structure 120, overall security of the computer system may be enhanced, e.g., because a user is more likely to select the emphasized dual-factor authentication protocol.

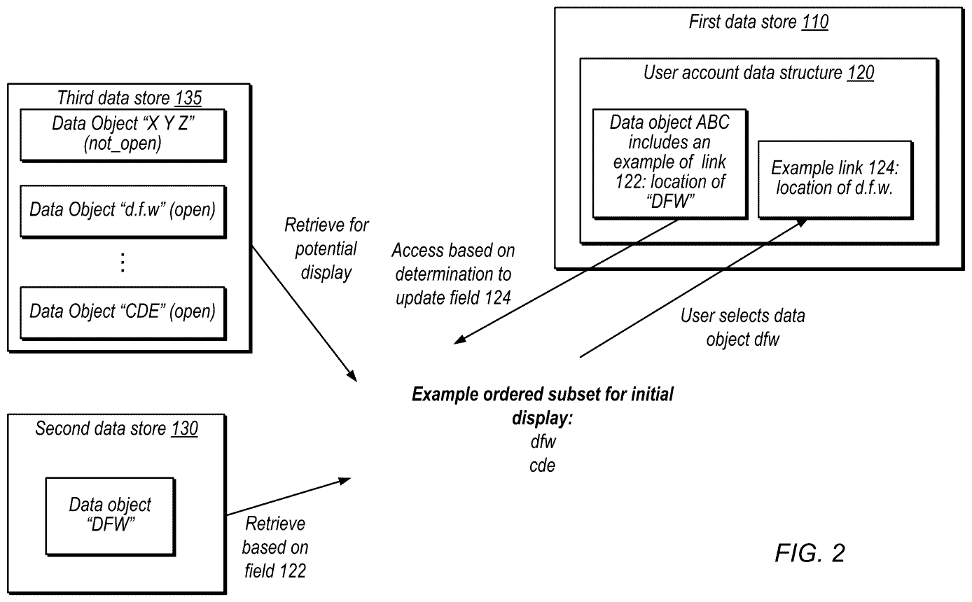

FIG. 2 is a diagram illustrating example operations to emphasize data objects for linking, according to some embodiments. In this example, data object ABC (an example of the first type of data object) includes a link 122 that indicates the location of data object DFW. For example, this may be a pointer, index, or other appropriate link to an entry in data store 130. As one example, ABC may represent a user account that is already linked to a two-factor authentication service represented by DFW or a user account that is already linked to another account represented by DFW.

In this example, control module 150 retrieves data object DFW from data store 130 and at least three data objects X Y Z, d.f.w, and CDE from data store 135. Standardization module 152 standardizes the data objects, e.g., to generate xyz, dfw, and cde. In this example, data object X Y Z has metadata that indicates it is not “open” (e.g., not open source, open protocol/standard, etc.) while the other two example data objects in data store 135 are open. In this example, only open data objects are included for display (in other examples, such metadata may be used to adjust emphasis rather than excluding data objects).

Based on the comparison after standardization, control module 150 puts object dfw from data store 135 at the top of the ordered list due to its match with data object DFW in data store 130. The user selects data object d.f.w. (e.g., a multi-factor authentication service) for linking in field 124 (e.g., for another user account, or for another function of the same user account ABC). DFW may be a particular type of multi-factor authentication, e.g., biometric authentication, location-based authentication, an authentication application, SMS authentication, etc. X Y Z, d.f.w., and CDE each may be different authentication methods, in this context.

As one example, “ABC” may be an account data structure of another account (e.g., a gaming account) that is associated with an account (e.g., a streaming account) also linked to user account data structure 120.

Consider another example applied to the field of banking. “ABC” may correspond to a user debit card and DFW may correspond to the issuing bank of the debit card. Data store 130 may also store metadata indicating frequency of use of ABC. Link 124 may be a link to a bank account, e.g., where the user account data structure 120 is a digital wallet. Data objects 136 may be banks that are eligible for linking using field 124. In this example, control module 150 may order the banks on a bank link user interface based on matches with existing issuer banks for which the user has already linked a debit card to their digital wallet. Disclosed techniques may advantageously allow recommendation of banking institutions at which the user is known to have a linked transaction instrument, potentially increasing the likelihood of linking.

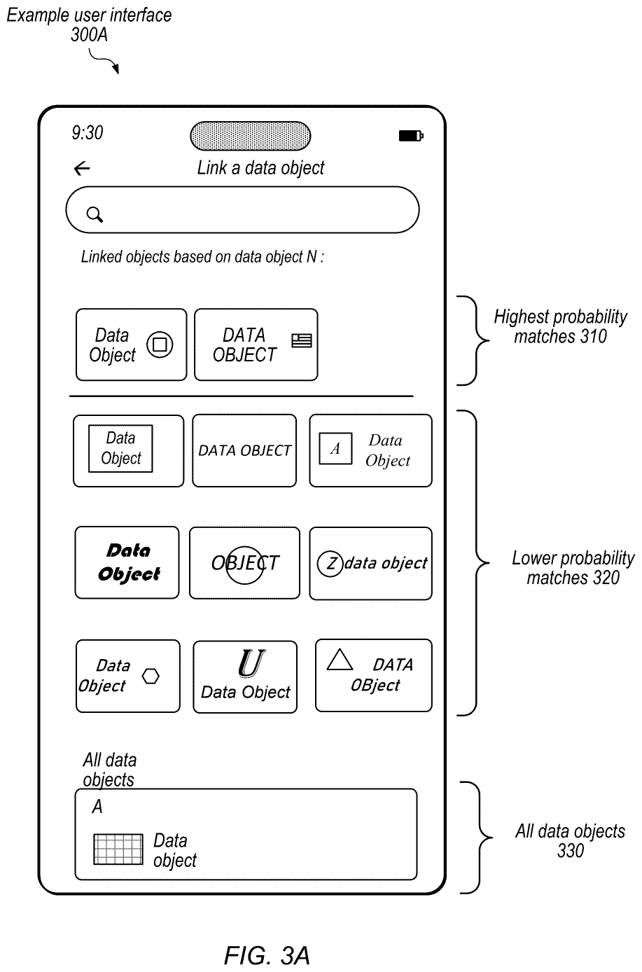

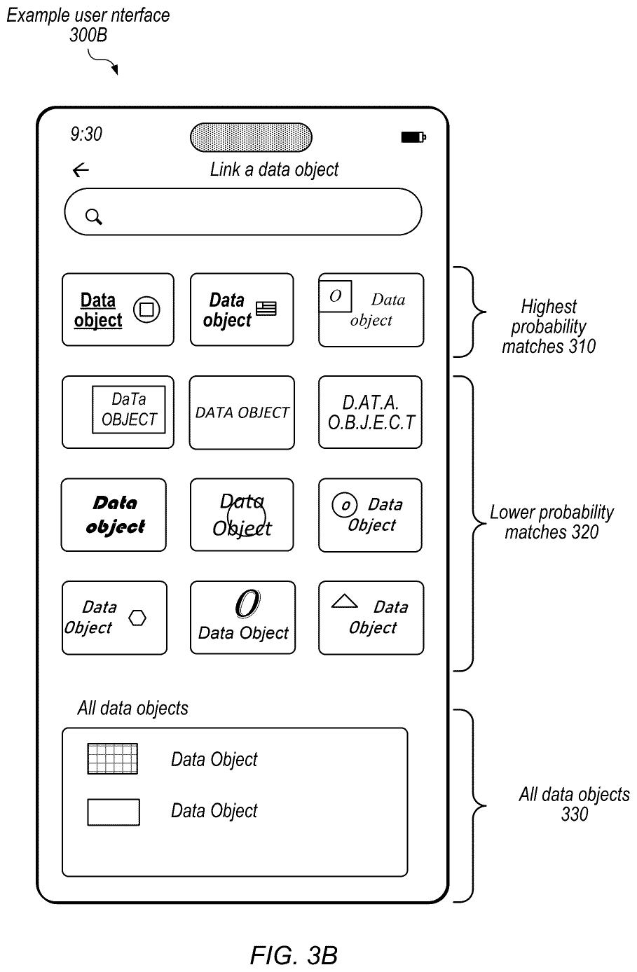

FIGS. 3A and 3B are discussed in detail below and illustrate two techniques for emphasizing certain data objects, although additional techniques are contemplated.

FIG. 3A is a diagram illustrating an example graphical user interface, according to some embodiments. In response to receipt by a computing device associated with a user of user interface information 140, graphical user interface 300A is displayable on a display of the computing device. In this example, data objects that meet a comparison threshold are displayed separately from the other data objects (e.g., the two top data objects are separated by other data objects by a horizontal line in the interface).

In this example, one region displays data objects 310 of the second type that have the highest match value with data object(s) of the third type 132. A second region displays lower probability matches 320 is usable to display data objects 136 that have a lower probability of a match to data object(s) of the third type 132. The third region is usable to display all data object(s) 330 (e.g., this may be a scrollable region in which a small number of data objects are displayed at a time, but all available data objects are accessible).

FIG. 3B is a diagram illustrating an example graphical user interface, according to some embodiments. Unlike in FIG. 3A, in which highest probability matches are displayed in a separate region, in user interface 300B, highest probability matches 310 are not displayed in a separate region but are ordered at the top of the displayed data objects.

By emphasizing data objects 136 that have a high probability of a match to one or more data objects 132, such as by including them in a separate region of a user interface (e.g., as in FIG. 3A) or ordered above other data object(s) (e.g., as in FIG. 3B), a user of a computing system advantageously may not need to scroll through a potentially voluminous quantity of data object(s) of a second type to identify their desired data object 132.

It is understood that FIGS. 3A and 3B are only examples of ways to emphasize data object(s) 136 that likely match data object(s) 132. Other techniques also are possible. For example, color-coding, special formatting (e.g., bolding, italicizing, etc.) may be used to emphasize data object(s) of a second type 136 that have a high probability of a match to data object(s) of a third type 132.

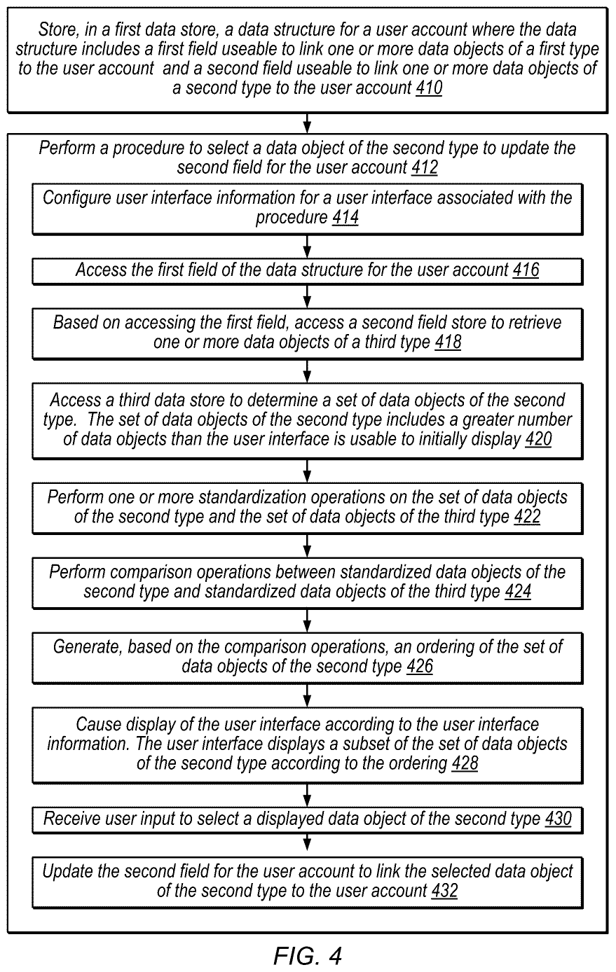

FIG. 4 is a flow diagram illustrating an example method, according to some embodiments. The illustrated method may be used in conjunction with any of the computer systems, devices, elements, or components disclosed herein, among other devices. In various embodiments, some of the method elements shown may be performed concurrently, in a different order than shown, or may be omitted. Additional method elements may also be performed if desired.

At 410, in the illustrated embodiment, a computing device (e.g., by executing instruction on one or more processors) stores, in a first data store, a data structure for a user account. The data structure includes a first field usable to link one or more data objects of a first type to the user account and a second field usable to link one or more data objects of a second type to the user account.

At 412, in the illustrated embodiment, the computing device performs a procedure to select a data object of the second type to update the second field for the user account. In the illustrated example, this includes elements 414-432.

At 414, in the illustrated embodiment, the computing device configures user interface information for a user interface associated with the procedure.

At 416, in the illustrated embodiment, the computing device accesses the first field of the data structure for the user account.

At 418, in the illustrated embodiment, the computing device, based on accessing the first field, accesses a second field store to retrieve one or more data objects of a third type.

At 420, in the illustrated embodiment, the computing device accesses a third data store to determine a set of data objects of the second type. The set of data objects of the second type includes a greater number of data objects than the user interface is usable to initially display.

At 422, the computing device performs one or more standardization operations of the set of data objects of the second type and the set of data objects of the third type.

At 424, the computing device performs comparison operations between standardized objects of the second type and standardized objects of the third type.

At 426, the computing device generates, based on the comparison operations, an ordering of the set of data objections of the second type.

At 428, the computing device causes display of the user interface according to the user interface information. The user interface displays a subset of the set of data objects of the second type according to the ordering.

At 432, the computing device updates the second field for the user account to link the selected data object of the second type to the user account.

In some embodiments, the comparison operations include a contain-match operation.

In some embodiments, the comparison operations include a cosine similarity comparison.

In some embodiments, to generate the ordering, the computing device sorts the data objects of the second type into a first subset that includes the one or more data objects of the second type having a threshold similarity value match with one of the one or more data objects of the third type and a second subset that does not have the threshold similarity value match.

In some embodiments, to cause the display of the user interface, the computing device causes display of the first subset in a first region of the user interface, and the computer device causes the display of the second subset in a second, different region of the user interface.

In some embodiments, the computer device accesses metadata from the second data store. In some embodiments, the ordering of the set of data objects of the second type is based on the metadata.

In some embodiments, the metadata indicates recency of utilization of the one or more data objects of the first type.

In some embodiments, to access the second data store, the computer device utilizes a first application programming interface (API). In some embodiments, to access the third data store, the computer device utilizes a second API. In some embodiments, to cause the display of the user interface, the computer device utilizes a third API.

In some embodiments, the computer device accesses metadata from the third data store that is associated with the one or more data objects of the second type. The metadata may indicate whether a given data object of the second type satisfies an open source criterion.

In some embodiments, the computer device displays the user interface.

In some embodiments, to perform the one or more standardization operations, the computer device removes spaces from the one or more data objects of the second type and from the one or more data objects of the third type and lowercases one or more data objects of the second type and one or more data objects of the third type. In some embodiments, to store the one or more data objects of the third type, the second data store implements a relational database or a key-value store.

Various techniques described herein, may be performed by one or more computer programs. The term “program” is to be construed broadly to cover a sequence of instructions in a programming language that a computing device can execute or interpret. These programs may be written in any suitable computer language, including lower-level languages such as assembly and higher-level languages such as Python.

Program instructions may be stored on a “non-transitory, computer-readable storage medium” or a “non-transitory, computer-readable medium.” The storage of program instructions on such media permits execution of the program instructions by a computer system. These are broad terms intended to cover any type of computer memory or storage device that is capable of storing program instructions. The term “non-transitory,” as is understood, refers to a tangible medium. Note that the program instructions may be stored on the medium in various formats (source code, compiled code, etc.).

The phrases “computer-readable storage medium” and “computer-readable medium” are intended to refer to both a storage medium within a computer system as well as a removable medium such as a CD-ROM, memory stick, or portable hard drive. The phrases cover any type of volatile memory within a computer system including DRAM, DDR RAM, SRAM, EDO RAM, Rambus RAM, etc., as well as non-volatile memory such as magnetic media, e.g., a hard drive, or optical storage. The phrases are explicitly intended to cover the memory of a server that facilitates downloading of program instructions, the memories within any intermediate computer system involved in the download, as well as the memories of all destination computing devices. Still further, the phrases are intended to cover combinations of different types of memories.

In addition, a computer-readable medium or storage medium may be located in a first set of one or more computer systems in which the programs are executed, as well as in a second set of one or more computer systems which connect to the first set over a network. In the latter instance, the second set of computer systems may provide program instructions to the first set of computer systems for execution. In short, the phrases “computer-readable storage medium” and “computer-readable medium” may include two or more media that may reside in different locations, e.g., in different computers that are connected over a network.

Note that in some cases, program instructions may be stored on a storage medium but not enabled to execute in a particular computing environment. For example, a particular computing environment (e.g., a first computer system) may have a parameter set that disables program instructions that are nonetheless resident on a storage medium of the first computer system. The recitation that these stored program instructions are “capable” of being executed is intended to account for and cover this possibility. Stated another way, program instructions stored on a computer-readable medium can be said to “executable” to perform certain functionality, whether or not current software configuration parameters permit such execution. Executability means that when and if the instructions are executed, they perform the functionality in question.

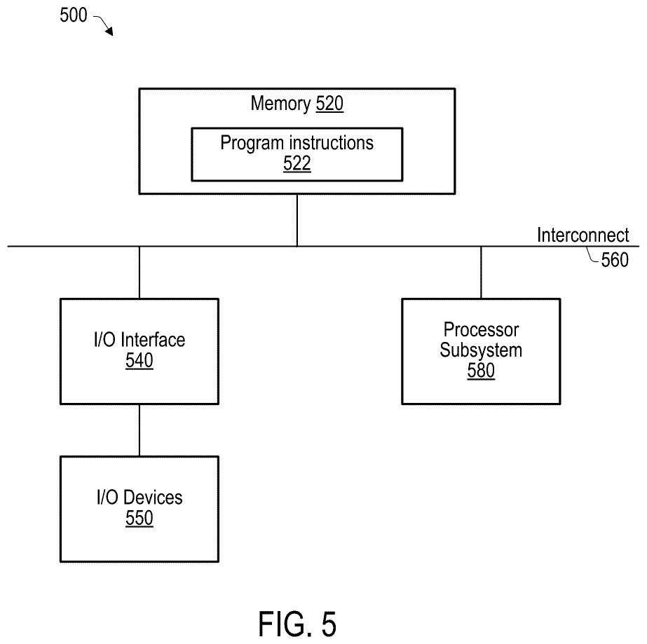

Similarly, systems that implement the methods described with respect to any of the disclosed techniques are also contemplated. One such system is described with reference to FIG. 5. FIG. 5 is a block diagram of another embodiment of such a computer system. Computer system 500 includes a processor subsystem 580 that is coupled to a memory 520 and I/O interfaces(s) 540 via an interconnect 560 (e.g., a system bus). I/O interface(s) 540 is coupled to one or more I/O devices 550. Computer system 500 may be any of various types of devices, including, but not limited to, a server system, personal computer system, desktop computer, laptop or notebook computer, mainframe computer system, tablet computer, handheld computer, workstation, network computer, a consumer device such as a mobile phone, music player, or personal data assistant (PDA). Although a single computer system 500 is shown in FIG. 5 for convenience, system 500 may also be implemented as two or more computer systems operating together.

Processor subsystem 580 may include one or more processors or processing units. In various embodiments of computer system 500, multiple instances of processor subsystem 580 may be coupled to interconnect 560. In various embodiments, processor subsystem 580 (or each processor unit within 1080) may contain a cache or other form of on-board memory.

Memory 520 is usable to store program instructions executable by processor subsystem 580 to cause system 500 perform various operations described herein. Memory 520 may be implemented using different physical memory media, such as hard disk storage, floppy disk storage, removable disk storage, flash memory, random access memory (RAM—SRAM, EDO RAM, SDRAM, DDR SDRAM, RAMBUS RAM, etc.), read only memory (PROM, EEPROM, etc.), and so on. Memory in computer system 500 is not limited to primary storage such as memory 520. Rather, computer system 500 may also include other forms of storage such as cache memory in processor subsystem 580 and secondary storage on I/O Devices 550 (e.g., a hard drive, storage array, etc.). In some embodiments, these other forms of storage may also store program instructions executable by processor subsystem 580.

I/O interfaces 540 may be any of various types of interfaces configured to couple to and communicate with other devices, according to various embodiments. In one embodiment, I/O interface 540 is a bridge chip (e.g., Southbridge) from a front-side to one or more back-side buses. I/O interfaces 540 may be coupled to one or more I/O devices 1050 via one or more corresponding buses or other interfaces. Examples of I/O devices 550 include storage devices (hard drive, optical drive, removable flash drive, storage array, SAN, or their associated controller), network interface devices (e.g., to a local or wide-area network), or other devices (e.g., graphics, user interface devices, etc.). In one embodiment, computer system 500 is coupled to a network via a network interface device 550 (e.g., configured to communicate over WiFi, Bluetooth, Ethernet, etc.).

Memory 520 may include a non-transitory computer-readable storage medium storing program instructions 522 in various embodiments. Program instructions 522 may include instructions that are executable to perform the method of FIG. 4, for example.

One particular environment in which the disclosed techniques may operate is a cloud computer system. A cloud computer system (or cloud computing system) refers to a computer system that provides on-demand availability of computer system resources without direct management by a user. These resources can include servers, storage, databases, networking, software, analytics, etc. Users typically pay only for those cloud services that are being used, which can, in many instances, lead to reduced operating costs. Various types of cloud service models are possible. The Software as a Service (SaaS) model provides users with a complete product that is run and managed by a cloud provider. The Platform as a Service (PaaS) model allows for deployment and management of applications, without users having to manage the underlying infrastructure. The Infrastructure as a Service (IaaS) model allows more flexibility by permitting users to control access to networking features, computers (virtual or dedicated hardware), and data storage space. Cloud computer systems can run applications in various computing zones that are isolated from one another. These zones can be within a single or multiple geographic regions.

A cloud computer system includes various hardware components along with software to manage those components and provide an interface to users. These hardware components include a processor subsystem, which can include multiple processor circuits, storage, and I/O circuitry, all connected via interconnect circuitry. Cloud computer systems thus can be thought of as server computer systems with associated storage that can perform various types of applications for users as well as provide supporting services (security, load balancing, user interface, etc.).

One common component of a cloud computing system is a data center. As is understood in the art, a data center is a physical computer facility that organizations use to house their critical applications and data. A data center's design is based on a network of computing and storage resources that enable the delivery of shared applications and data.

The term “data center” is intended to cover a wide range of implementations, including traditional on-premises physical servers to virtual networks that support applications and workloads across pools of physical infrastructure and into a multi-cloud environment. In current environments, data exists and is connected across multiple data centers, the edge, and public and private clouds. A data center can frequently communicate across these multiple sites, both on-premises and in the cloud. Even the public cloud is a collection of data centers. When applications are hosted in the cloud, they are using data center resources from the cloud provider. Data centers are commonly used to support a variety of enterprise applications and activities, including, email and file sharing, productivity applications, customer relationship management (CRM), enterprise resource planning (ERP) and databases, big data, artificial intelligence, machine learning, virtual desktops, communications and collaboration services.

Data centers commonly include routers, switches, firewalls, storage systems, servers, and application delivery controllers. Because these components frequently store and manage business-critical data and applications, data center security is critical in data center design. These components operate together provide the core infrastructure for a data center: network infrastructure, storage infrastructure and computing resources. The network infrastructure connects servers (physical and virtualized), data center services, storage, and external connectivity to end-user locations. Storage systems are used to store the data that is the fuel of the data center. In contrast, applications can be considered to be the engines of a data center. Computing resources include servers that provide the processing, memory, local storage, and network connectivity that drive applications. Data centers commonly utilize additional infrastructure to support the center's hardware and software. These include power subsystems, uninterruptible power supplies (UPS), ventilation, cooling systems, fire suppression, backup generators, and connections to external networks.

Data center services are typically deployed to protect the performance and integrity of the core data center components. Data center therefore commonly use network security appliances that provide firewall and intrusion protection capabilities to safeguard the data center. Data centers also maintain application performance by providing application resiliency and availability via automatic failover and load balancing.

One standard for data center design and data center infrastructure is ANSI/TIA-942. It includes standards for ANSI/TIA-942-ready certification, which ensures compliance with one of four categories of data center tiers rated for levels of redundancy and fault tolerance. A Tier 1 (basic) data center offers limited protection against physical events. It has single-capacity components and a single, nonredundant distribution path. A Tier 2 data center offers improved protection against physical events. It has redundant-capacity components and a single, nonredundant distribution path. A Tier 3 data center protects against virtually all physical events, providing redundant-capacity components and multiple independent distribution paths. Each component can be removed or replaced without disrupting services to end users. A Tier 4 data center provides the highest levels of fault tolerance and redundancy. Redundant-capacity components and multiple independent distribution paths enable concurrent maintainability and one fault anywhere in the installation without causing downtime.

Many types of data centers and service models are available. A data center classification depends on whether it is owned by one or many organizations, how it fits (if at all) into the topology of other data centers, the technologies used for computing and storage, and its energy efficiency. There are four main types of data centers. Enterprise data centers are built, owned, and operated by companies and are optimized for their end users. In many cases, they are housed on a corporate campus. Managed services data centers are managed by a third party (or a managed services provider) on behalf of a company. The company leases the equipment and infrastructure instead of buying it. In colocation (“colo”) data centers, a company rents space within a data center owned by others and located off company premises. The colocation data center hosts the infrastructure: building, cooling, bandwidth, security, etc., while the company provides and manages the components, including servers, storage, and firewalls. Cloud data centers are an off-premises form of data center in which data and applications are hosted by a cloud services provider such as AMAZON WEB SERVICES (AWS), MICROSOFT (AZURE), or IBM Cloud.

The present disclosure includes references to “embodiments,” which are non-limiting implementations of the disclosed concepts. References to “an embodiment,” “one embodiment,” “a particular embodiment,” “some embodiments,” “various embodiments,” and the like do not necessarily refer to the same embodiment. A large number of possible embodiments are contemplated, including specific embodiments described in detail, as well as modifications or alternatives that fall within the spirit or scope of the disclosure. Not all embodiments will necessarily manifest any or all of the potential advantages described herein.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages often depends on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (i.e., a noun or noun phrase preceded by “a,” “an,” or “the”) are, unless context clearly dictates otherwise, intended to mean “one or more.” Reference to “an item” in a claim thus does not, without accompanying context, preclude additional instances of the item. A “plurality” of items refers to a set of two or more of the items.

The word “may” be used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or” is being used in the exclusive sense.

A recitation of “w, x, y, or z, or any combination thereof” or “at least one of . . . w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” “given circuit,” etc.) refer to different instances of the feature. Additionally, the labels “first,” “second,” and “third” when applied to a feature do not imply any type of ordering (e.g., spatial, temporal, logical, etc.), unless stated otherwise.

The phrase “based on” or is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical). More specifically, this formulation is used to indicate that this structure is arranged to perform the one or more tasks during operation. A structure can be said to be “configured to” perform some tasks even if the structure is not currently being operated. Thus, an entity described or recited as being “configured to” perform some tasks refers to something physical, such as a device, circuit, a system having a processor unit and a memory storing program instructions executable to implement the task, etc. This phrase is not used herein to refer to something intangible.

In some cases, various units/circuits/components may be described herein as performing a set of task or operations. It is understood that those entities are “configured to” perform those tasks/operations, even if not specifically noted.

The term “configured to” is not intended to mean “configurable to.” An unprogrammed FPGA, for example, would not be considered to be “configured to” perform a particular function. This unprogrammed FPGA may be “configurable to” perform that function, however. After appropriate programming, the FPGA may then be said to be “configured to” perform the particular function.

For purposes of United States patent applications based on this disclosure, reciting in a claim that a structure is “configured to” perform one or more tasks is expressly intended not to invoke 35 U.S.C. § 112(f) for that claim element. Should Applicant wish to invoke Section 112(f) during prosecution of a United States patent application based on this disclosure, it will recite claim elements using the “means for” [performing a function] construct.

What is claimed is:

1. An apparatus, comprising:
one or more processors; and
one or more memories having program instructions stored thereon, the program instructions executable by the one or more processors to:
store, in a first data store, a data structure for a user account, wherein the data structure includes a first field usable to link one or more data objects of a first type to the user account and a second field usable to link one or more data objects of a second type to the user account;
perform a procedure to select a data object of the second type to update the second field for the user account, wherein, to perform the procedure, the program instructions are executable by the one or more processors to:
configure user interface information for a user interface associated with the procedure;
access the first field of the data structure for the user account;
based on the access to the first field, access a second data store to retrieve one or more data objects of a third type;
access a third data store to determine a set of data objects of the second type, wherein the set of data objects of the second type includes a greater number of data objects than the user interface is usable to initially display;
perform one or more standardization operations on the set of data objects of the second type and the set of data objects of the third type;
perform comparison operations between standardized data objects of the second type and standardized data objects of the third type;
generate, based on the comparison operations, an ordering of the set of data objects of the second type;
cause display of the user interface according to the user interface information, wherein the user interface displays a subset of the set of data objects of the second type according to the ordering;
receive user input to select a displayed data object of the second type; and
update the second field for the user account to link the selected data object of the second type to the user account.

2. The apparatus of claim 1, wherein, to generate the ordering, the program instructions are executable by the one or more processors to sort the data objects of the second type into:
a first subset that includes the one or more data objects of the second type having a threshold similarity value match with one of the one or more data objects of the third type; and
a second subset that does not have the threshold similarity value match.

3. The apparatus of claim 2, wherein, to cause display of the user interface, the program instructions are executable by the one or more processors to:
cause display of the first subset in a first region of the user interface; and
cause the display of the second subset in a second, different region of the user interface.

4. The apparatus of claim 1, wherein the program instructions are executable by the one or more processors to accesses metadata from the second data store, wherein the ordering of the set of data objects of the second type is based on the metadata.

5. The apparatus of claim 4, wherein the metadata indicates recency of utilization of the one or more data objects of the first type.

6. A method, comprising:
storing, by a computing system in a first data store, a data structure for a user account, wherein the data structure includes a first field usable to link one or more data objects of a first type to the user account and a second field usable to link one or more data objects of a second type to the user account;
performing, by the computing system, a procedure to select a data object of the second type to update the second field for the user account, wherein the procedure includes:
configuring user interface information for a user interface associated with the procedure;
accessing the first field of the data structure for the user account;
based on the accessing the first field, accessing a second data store to retrieve one or more data objects of a third type;
accessing a third data store to determine a set of data objects of the second type, wherein the set of data objects of the second type includes a greater number of data objects than the user interface is usable to initially display;
performing one or more standardization operations on the set of data objects of the second type and the set of data objects of the third type;
performing comparison operations between standardized data objects of the second type and standardized data objects of the third type;
generating, based on the comparison operations, an ordering of the set of data objects of the second type;
causing, by the computing system, display of the user interface according to the user interface information, wherein the user interface displays a subset of the set of data objects of the second type according to the ordering;
receiving, by the computing system, user input to select a displayed data object of the second type; and
updating the second field for the user account to link the selected data object of the second type to the user account.

7. The method of claim 6, wherein the comparison operations include a contain-match operation.

8. The method of claim 6, wherein the comparison operations include a cosine similarity comparison.

9. The method of claim 6, wherein the generating the ordering includes sorting the data objects of the second type into:
a first subset that includes the one or more data objects of the second type having a threshold similarity value match with one of the one or more data objects of the third type; and
a second subset that does not have the threshold similarity value match.

10. The method of claim 9, wherein the causing includes:
causing, by the computing system, display of the first subset in a first region of the user interface; and
causing, by the computing system, the display of the second subset in a second, different region of the user interface.

11. The method of claim 6, further comprising accessing metadata from the second data store, wherein the ordering of the set of data objects of the second type is based on the metadata.

12. The method of claim 11, wherein the metadata indicates recency of utilization of the one or more data objects of the first type.

13. The method of claim 6, wherein:
the accessing the second data store utilizes a first application programming interface (API);
the accessing the third data utilizes a second API; and
the causing the display of the user interface utilizes a third API.

14. The method of claim 6, further comprising:
accessing metadata from the third data store that is associated with the one or more data objects of the second type, wherein the metadata indicates whether a given data object of the second type satisfies an open source criterion.

15. The method of claim 6, further comprising displaying the user interface.

16. The method of claim 6, wherein the performing the one or more standardization operations includes removing spaces from the one or more data objects of the second type and from the one or more data objects of the third type and lowercasing one or more data objects of the second type and one or more data objects of the third type.

17. The method of claim 6, wherein the second data store implements, to store the one or more data objects of the third type, a relational database or a key-value store.

18. A non-transitory computer-readable medium having instructions stored thereon that are executable by a computing device to perform operations comprising:
storing, by a computing system in a first data store, a data structure for a user account, wherein the data structure includes a first field usable to link one or more data objects of a first type to the user account and a second field usable to link one or more data objects of a second type to the user account;
performing, by the computing system, a procedure to select a data object of the second type to update the second field for the user account, wherein the procedure includes:
configuring user interface information for a user interface associated with the procedure;
accessing the first field of the data structure for the user account;
based on the accessing the first field, accessing a second data store to retrieve one or more data objects of a third type;
accessing a third data store to determine a set of data objects of the second type, wherein the set of data objects of the second type includes a greater number of data objects than the user interface is usable to initially display;
performing one or more standardization operations on the set of data objects of the second type and the set of data objects of the third type;
performing comparison operations between standardized data objects of the second type and standardized data objects of the third type;
generating, based on the comparison operations, an ordering of the set of data objects of the second type;
causing, by the computing system, display of the user interface according to the user interface information, wherein the user interface displays a subset of the set of data objects of the second type according to the ordering;
receiving, by the computing system, user input to select a displayed data object of the second type; and
updating the second field for the user account to link the selected data object of the second type to the user account.

19. The non-transitory computer-readable medium of claim 17, wherein the generating the ordering includes sorting the data objects of the second type into:
a first subset that includes the one or more data objects of the second type having a threshold similarity value match with one of the one or more data objects of the third type; and
a second subset that does not have the threshold similarity value match.

20. The non-transitory computer-readable medium of claim 19, wherein the causing includes:
causing, by the computing system, display of the first subset in a first region of the user interface; and
causing, by the computing system, the display of the second subset in a second, different region of the user interface.
